(19) United States
(12) Patent Application Publication
(10) Pub. No.: US 2018/0226775 A1
(43) Pub. Date: Aug. 9, 2018

(54) Wire Stripping and Cutting Tool

(71) Applicant: Carlos A. Vigil, Albuquerque, NM (US)

(72) Inventor: Carlos A. Vigil, Albuquerque, NM (US)

(21) Appl. No.: 15/892,098

(22) Filed: Feb. 8, 2018

Related U.S. Application Data
(60) Provisional application No. 62/456,458, filed on Feb. 8, 2017.

(51) Int. Cl. H02G 1/00; H02G 1/12; B25G 1/10

(52) U.S. Cl. CPC H02G 1/005; B25G 1/102; H02G 1/1212; H02G 1/1236

(57) ABSTRACT

A wire stripping and cutting tool. The tool includes a pair of arms each including a head end with pliers and a handle end pivotally affixed to one another via a fastener. Each arm of the pair of arms includes a cutting portion disposed on the head portion, and a pair of screw cutting apertures disposed between the cutting portion and the handle portion. A first group of wire stripping notches disposed on the head portion include a first diameter, and a second group of wire stripping notches disposed on the head portion has a second diameter greater than the first diameter. In one embodiment, the first and second group of notches are configured to strip 12.2 and 14.2 gauge wires, respectively. A spring is disposed between each arm, wherein the spring is configured to bias each head portion of each arm in a direction opposing each other.

### CROSS REFERENCE TO RELATED APPLICATIONS

This application claims the benefit of U.S. Provisional Application No. 62/456,458 filed on Feb. 8, 2017. The above identified patent application is herein incorporated by reference in its entirety to provide continuity of disclosure.

### BACKGROUND OF THE INVENTION

The present invention relates to devices and tools for cutting and stripping wires. More specifically, the present invention provides a wire stripping and cutting tool that includes multiple linearly-arranged groupings of wire stripping notches, allowing for multiple wires of the same gauge to be stripped simultaneously.

Traditional wire stripping devices existing in the known art are often utilized while installing or repairing electrical wiring systems. Such devices often include mechanisms for removing the insulating jacket from a wire, also known as stripping the wire, and blades for cutting the wires to a desired length. Some of these devices have multiple stripping mechanisms that allow different sized wires to be individually stripped. However, traditional wire strippers are only capable of stripping one wire at a time. It can be an exhausting and time-consuming process to strip a great amount of wires. For example, having to strip individual wires can cause wear and tear on the hands and fingers. Stripping one wire at a time decreases productivity and increases strain and stress on the body. In view of the above concerns, it is desirable to provide a wire stripping and cutting tool that allows users to strip multiple wires simultaneously, in order to reduce the amount of time it takes to complete a wiring job and reduce overall strain on the user's body.

In light of the devices disclosed in the known art, it is submitted that the present invention substantially diverges in design elements from the known art and consequently it is clear that there is a need in the art for an improvement to existing wire stripping and cutting devices. In this regard the present invention substantially fulfills these needs.

### SUMMARY OF THE INVENTION

In view of the foregoing disadvantages inherent in the known types of wire stripping devices now present in the prior art, the present invention provides a wire stripping and cutting tool wherein the same can be utilized for providing convenience for the user when stripping multiple wires simultaneously. The present wire cutting and stripping tool includes a pair of arms each including a head portion and a handle portion, wherein the pair of arms are pivotally affixed to one another via a fastener. Each arm of the pair of arms includes a cutting portion disposed on the head portion and a pair of screw cutting apertures disposed between the cutting portion and the handle portion. A first group of wire stripping notches is disposed on the head portion of each arm in a linear arrangement, wherein each notch of the first group of notches includes a first diameter. A second group of wire stripping notches is disposed on the head portion of each arm in a linear arrangement, wherein each notch of the second group of notches includes a second diameter, wherein the second diameter is greater than the first diameter. A spring is disposed between each arm, wherein the spring is configured to bias each head portion of each arm in a direction opposing each other, such that the head portions are biased to an open position.

One object of the present invention is to provide a wire stripping and cutting tool that allows users to strip multiple wires simultaneously.

Another object of the present invention is to provide a wire stripping and cutting tool that includes a first grouping of notches configured to strip 12.2 gauge wires and a second grouping of notches configured to strip 14.2 gauge wires.

A further object of the present invention is to provide a wire stripping and cutting tool that includes wire looping holes for looping wire therethrough in order to releasably secure the wire to the tool.

Yet another object of the present invention is to provide a wire stripping and cutting tool that includes grips on the handles thereof, wherein the grips include a phosphorescent material, such that the grips can glow in the dark.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of one embodiment of the wire stripping and cutting tool.

FIG. 2 shows an exploded view of one embodiment of the wire stripping and cutting tool.

### DETAILED DESCRIPTION OF THE INVENTION

Reference is made herein to the attached drawings. Like reference numerals are used throughout the drawings to depict like or similar elements of the wire stripping and cutting tool. For the purposes of presenting a brief and clear description of the present invention, the preferred embodiment will be discussed as used for stripping multiple wires simultaneously and overall decrease the amount of time it takes to complete a wiring job. The figures are intended for representative purposes only and should not be considered to be limiting in any respect.

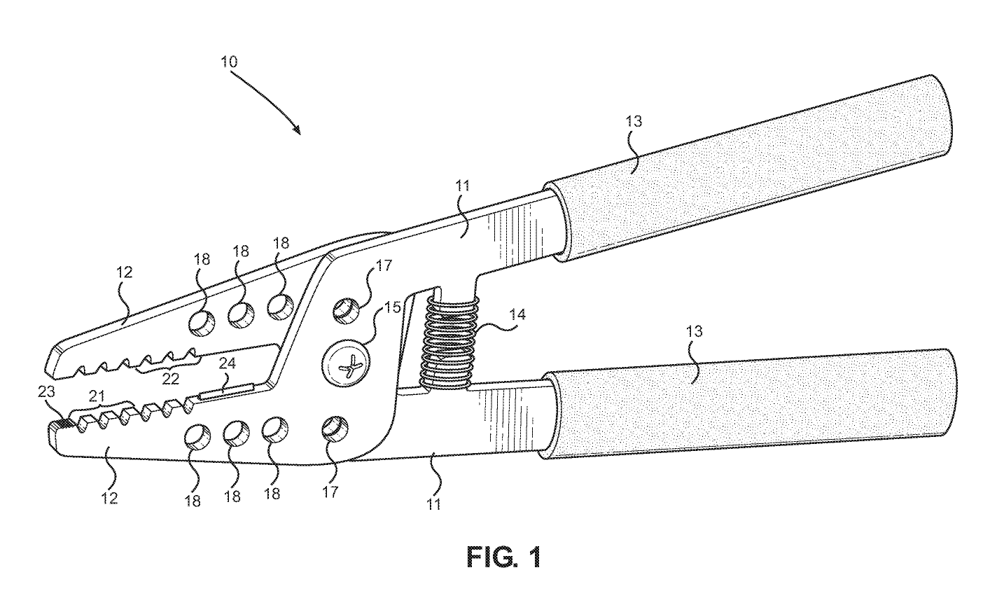

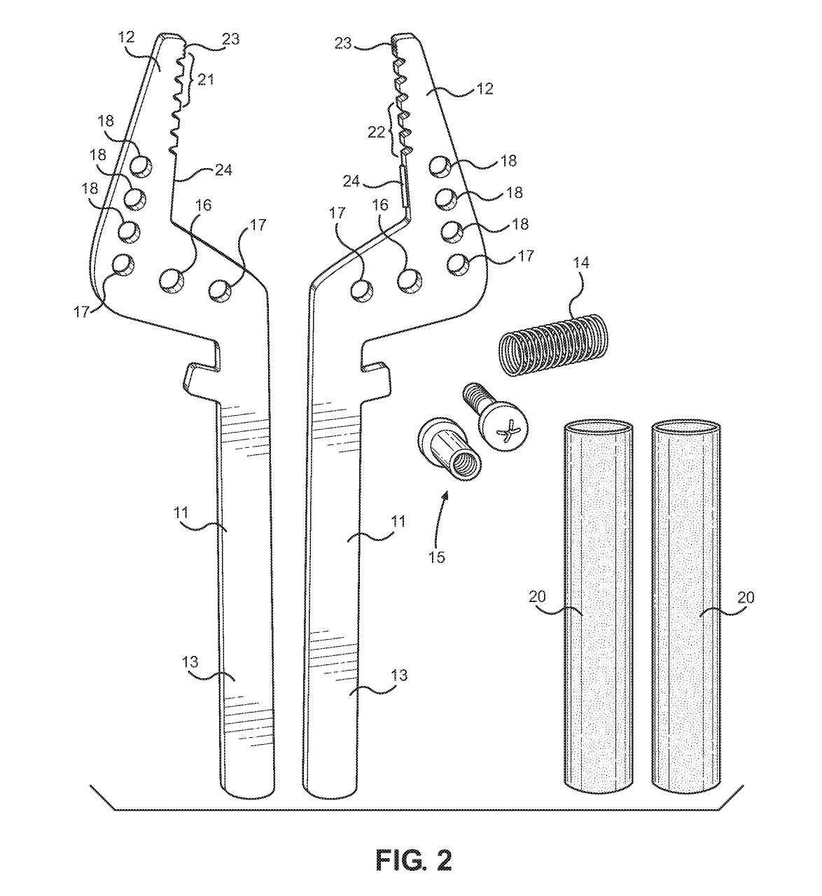

Referring now to FIGS. 1 and 2, there is shown a perspective view of one embodiment of the wire stripping and cutting tool and an exploded view of one embodiment of the wire stripping and cutting tool, respectively. The wire stripping and cutting tool 11 generally comprises a pair of arms 11 that are pivotally affixed to one another via a fastener 15 that extends through a fastener aperture 16 on each arm 11. In the illustrated embodiment, the fastener 15 is a nut and bolt fastening system. However, alternate fasteners may be utilized to achieve the pivoted connection, such as a rivet or the like. Each arm 11 is composed from a durable material such as aluminum, steel, or other metals.

The arms 11 each include a handle portion 13 and a head portion 12. In operation, the handle portion 13 is gripped by the user, while the working implements of the tool 10 are disposed on the head portion 12. A spring 14 is disposed between each arm 11. In the illustrated embodiment, each arm 11 includes a tab that inserts into one open end of the spring 14, effectively securing the spring 14 between the arms. The spring 14 is configured to bias each head portion 12 in a direction opposing each other. In other words, the spring 14 causes the tool 10 to maintain a default open position, while squeezing the handle portions 13 together forces the tool 10 to a closed position.

The tool 10 includes various functional components. The tip of the head portion 12 includes a pliers 24 thereon, which consist of a plurality of grooves that enable gripping of an object with the tool 10. The tool 10 additionally includes a plurality of wire stripping notches. The wire stripping notches are arranged in a first grouping 21 and an adjacent second grouping 22. The first grouping 21 includes three linearly arranged notches each having a first diameter, and the second grouping 22 includes three linearly arranged notches each having a second diameter. The second diameter is greater than the first diameter, meaning each grouping of notches corresponds to a particular gauge of wire. In the illustrated embodiment, the first grouping 21 of notches is configured to strip the insulation jacket from up to three 12.2 gauge wires simultaneously, while the second grouping 22 of notches is configured to strip the insulation jacket from up to three 14.2 gauge wires simultaneously. In this way, the present wire stripping and cutting tool 10 can be utilized to strip multiple wires at the same time.

Each arm 11 of the wire stripping and cutting tool 10 includes a cutting portion 24 disposed on the head portion 12. The cutting portions 24 of each arm 11 make contact when the handle portions 13 are pressed together, allowing the cutting portions 24 to snip a wire positioned therebetween. Each arm 11 further includes a pair of screw cutting apertures 17 disposed between the cutting portion 19 and the handle portion 13. The screw cutting apertures 17 includes a first screw cutting aperture having a first diameter and a second screw cutting aperture having a second diameter, wherein the second diameter is greater than the first diameter, allowing different sizes of screws to be cut. In the illustrate embodiment, one screw cutting aperture 17 is configured to cut #6-32 screws, while the other screw cutting aperture 17 is configured to cut #8-32 screws. Each arm 11 also includes a plurality of wire looping holes 18 disposed on the head portion 12 adjacent the cutting portion 19. In the shown embodiment, there are three wire looping holes 18 disposed in a linear arrangement. Also, in the shown embodiment, the wire looping holes 18 include a diameter equal to two millimeters, which allows wires of varying gauges to be looped therethrough. A user may loop a wire through the looping holes 18 in order to temporarily secure the end of the wire to the head portion 12 of the tool 10.

Each arm 11 further includes a grip 20 disposed over the handle portion 13. The grip 20 is preferably composed of rubber or another material that increases friction and allows a user to comfortably grasp the tool 10. In some embodiments, the grips 20 include a phosphorescent material. This allows the grips 20 to glow in the dark, enhancing visibility for the user in low-light conditions. The grips 20 may be permanently affixed to the arms 11, or may be removable for customization or cleaning purposes. Overall, the present invention provides a wire stripping and cutting tool 10 that includes various features for increasing the efficiency of the wiring installation process.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wire stripping and cutting tool, comprising:
a pair of arms each including a head portion and a handle portion, the pair of arms pivotally affixed to one another via a fastener, each arm of the pair of arms comprising:
a cutting portion disposed on the head portion;
a pair of screw cutting apertures disposed between the cutting portion and the handle portion;
a first group of wire stripping notches disposed on the head portion in a linear arrangement, each notch of the first group of notches having a first diameter;
a second group of wire stripping notches disposed on the head portion in a linear arrangement, each notch of the second group of notches having a second diameter, wherein the second diameter is greater than the first diameter; and
a spring disposed between each arm, wherein the spring is configured to bias each head portion of each arm in a direction opposing each other.

2) The wire stripping and cutting tool of claim 1, wherein each notch of the first group of notches is sized to engage and strip an insulating jacket of a 14.2 gauge wire, and wherein each notch of the second group of notches is sized to engage and strip an insulating jacket of a 12.2 gauge wire.

3) The wire stripping and cutting tool of claim 1, wherein the pair of screw cutting apertures includes a first screw cutting aperture having a first diameter and a second screw cutting aperture having a second diameter, wherein the second diameter is greater than the first diameter.

4) The wire stripping and cutting tool of claim 1, wherein each arm further comprises a plurality of wire looping holes disposed on the head portion adjacent the cutting portion.

5) The wire stripping and cutting tool of claim 4, wherein the plurality of wire looping holes includes three wire looping holes disposed in a linear arrangement.

6) The wire stripping and cutting tool of claim 4, wherein each wire looping hole includes a diameter of 2 millimeters.

7) The wire stripping and cutting tool of claim 1, further comprising a grip disposed on the handle end of each arm.

8) The wire stripping and cutting tool of claim 7, wherein each grip includes a phosphorescent material.

9) The wire stripping and cutting tool of claim 1, wherein the fastener is a bolt and nut fastener.

10) The wire stripping and cutting tool of claim 1, wherein each arm is composed of a metallic material.
